(19) United States
(12) Patent Application Publication
(10) Pub. No.: US 2026/0219938 A1
(43) Pub. Date: Jul. 30, 2026

(54) DYNAMIC RESOURCE SCALING FOR WEB CRAWLING

(71) Applicant: Salesforce, Inc., San Francisco, CA (US)

(72) Inventor: Jose Lejin P J, Bangalore (IN)

(21) Appl. No.: 19/041,178

(22) Filed: Jan. 30, 2025

(51) Int. Cl. G06F 9/50; G06F 16/951

(52) U.S. Cl. CPC G06F 9/5027; G06F 16/951

(57) ABSTRACT

A system may monitor behavior of first web crawling bots traversing a plurality of web pages to generate behavior information associated with the plurality of first web crawling bots. The system may store at least a portion of the behavior information in a behavior matrix. The system may receive plain language configuration instructions that describe one or more rules for allocating processing resources associated with serving the plurality of web pages. The system may detect a presence of a second web crawling bot accessing one or more first web pages of the plurality of web pages. The system may allocate the processing resources for the plurality of web pages in accordance with the one or more rules and based at least in part on detecting the presence of the second web crawling bot.

### FIELD OF TECHNOLOGY

The present disclosure relates generally to database systems and data processing, and more specifically to dynamic resource scaling for web crawling.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, a system may allocate resources for serving web pages or other resources. However, such methods may be improved.

### BRIEF DESCRIPTION OF THE DRAWINGS

FIG. 1 illustrates an example of a data processing system that supports dynamic resource scaling for web crawling in accordance with examples as disclosed herein.

FIG. 2 shows an example of a resource allocation system that supports dynamic resource scaling for web crawling in accordance with examples as disclosed herein.

FIG. 3 shows an example of a resource allocation system that supports dynamic resource scaling for web crawling in accordance with examples as disclosed herein.

FIG. 4 shows an example of a process flow that supports dynamic resource scaling for web crawling in accordance with examples as disclosed herein.

FIG. 5 shows a block diagram of an apparatus that supports dynamic resource scaling for web crawling in accordance with examples as disclosed herein.

FIG. 6 shows a block diagram of a resource scaling manager that supports dynamic resource scaling for web crawling in accordance with examples as disclosed herein.

FIG. 7 shows a diagram of a system including a device that supports dynamic resource scaling for web crawling in accordance with examples as disclosed herein.

FIG. 8 shows a flowchart illustrating methods that support dynamic resource scaling for web crawling in accordance with examples as disclosed herein.

### DETAILED DESCRIPTION

Web applications are routinely accessed by web crawler bots, which index and analyze content across various uniform resource locators (URLs). For owners of websites, such crawling of their web applications, pages, services, and URLs may be desirable, as crawling may facilitate appearance of the URLs and the contents thereof in search engine results or other indexing or logging by other services that utilize such web crawling bots. Web applications often include multiple URLs, each involving various back-end resources to render their contents. When web crawlers access these URLs, they can trigger associated resource consumption spikes, which may be difficult to predict and manage with traditional auto-scaling mechanisms. These systems may react to system-wide metrics, such as CPU or memory usage, rather than URL-specific patterns, leading to over-allocation or under-allocation of resources. Traditional auto-scaling mechanisms lack the precision to allocate resources based on real-time URL access patterns. Further, different web crawlers may crawl URLs differently, and some URLs may receive disproportionately more traffic than others, while some URLs may not be accessed. Administrators face the challenge of preemptively scaling backend resources for URL related web app contents, often resulting in keeping all resources scaled up or scaled down without precision. This approach is inefficient and leads to unnecessary costs and computational resource wastage.

The subject matter described herein may offer improved scaling of resources for URLs in a web application when crawled by web crawling bots. For example, a system may collect and store behavior information (e.g., a matrix of URL-to-URL transitions, bot identities, bot operations, resource usage, rendering information, other data, or any combination thereof that describes how URLs are accessed and the contents thereof are rendered) representing behavior of the web crawlers when they crawl the URLs. This information may be processed by a generative artificial intelligence (AI) system to analyze which URLs could benefit from additional resources and which URLs could be served for crawling operations using fewer resources. Resource allocation may be performed accordingly, to provide adequate resources for web crawling with reduced resource waste (e.g., due to overallocation of other resources as occurs in other approaches).

In some examples, the system may predict resource usage based on patterns detected in the behavior information and prior resource usage. In some examples, the system may generate allocation instructions to scale up or scale down resources associated with URLs based on predefined conditions set by administrators in plain language. In some examples, if a web crawler is currently accessing a specific URL, the system may predict the next set of URLs that will be accessed and instruct the web server to scale up resources for those URLs accordingly.

Aspects of the disclosure are initially described in the context of an environment supporting an on-demand database service. Aspects of the disclosure are then described with reference to a resource allocation system, a resource allocation system, and a process flow. Aspects of the disclosure are further illustrated by and described with reference to apparatus diagrams, system diagrams, and flowcharts that relate to dynamic resource scaling for web crawling.

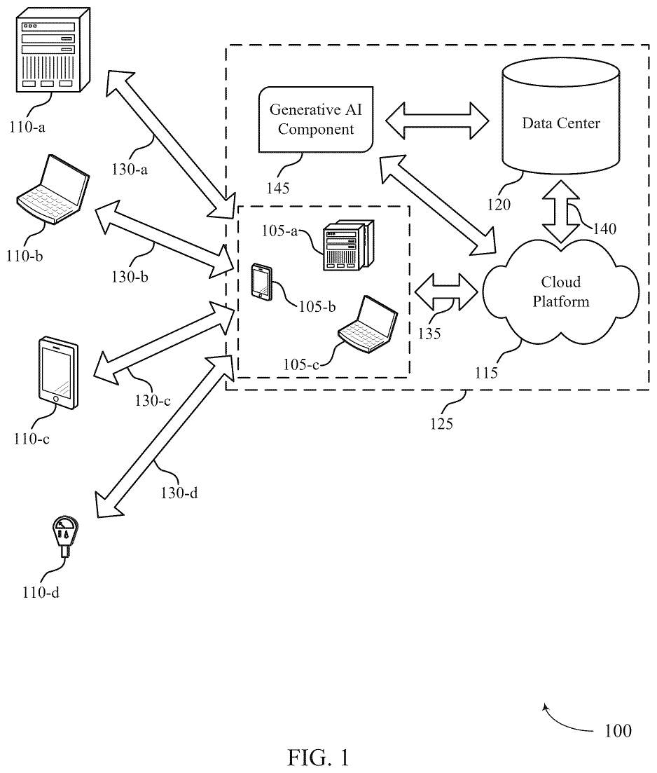

FIG. 1 illustrates an example of a system 100 for cloud computing that supports dynamic resource scaling for web crawling in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, the cloud platform 115 may receive (e.g., from a cloud client 105) plain language instructions that define or indicate one or more rules for resource allocation for web crawling operations of web resources (e.g., web pages, web applications, or other information or applications accessible by the web crawling bots) associated with the cloud platform 115. The cloud platform 115 may monitor operations of one or more web crawling bots across the web resources and may obtain behavior information based on the operations and may store at least a portion of the behavior information in a behavior matrix (e.g., that represents URL-to-URL transitions or crawling “paths” taken by the web crawling bots), another storage structure or method, or any combination thereof. The cloud platform 115 may analyze (e.g., through the use of the generative AI component 145) the behavior information and may allocate resources used to provide or serve the web resources to accommodate the web crawling operations without over-allocating resources that may not be fully utilized to serve the web resources to the web crawling bots.

In other approaches, systems that serve web pages, applications, or other web resources may be crawled by crawler bots. However, such crawling may trigger associated resource consumption spikes, which are difficult to predict and manage with other scaling mechanisms. For example, such systems may under-allocate resources for serving web pages, and a web crawler may not be able to crawl the web page with such limited resources. Other auto-scaling mechanisms may over-compensate for such a deficiency, providing more resources than would be occupied by the crawling operations, resulting in wasted resources. Furthermore, different web crawlers may crawl URLs differently, and some URLs may receive disproportionately more traffic than others, while some URLs may not be accessed. Administrators face the challenge of preemptively scaling backend resources for URLs related web app contents, often resulting in keeping all resources scaled up or scaled down without precision. This approach is inefficient and leads to unnecessary costs and computational resource wastage.

In some examples, the system may track behavior of the web crawling bots (e.g., URL-to-URL transitions, contents rendered, identifiers of the web crawling bots, or other behavior as described herein) and may store some or all such information in a matrix (e.g., a URL-to-URL transition matrix that describes the “paths” taken by the crawling bots). This matrix may be analyzed by a generative AI model to determine which URLs, pages, or applications may benefit from additional resources and which could be served with fewer resources. Such scaling may be more accurate than other approaches due at least in part to the tracking and analysis of the behavior information. Further, the generative AI model may interpret plain language instructions from administrators to define one or more rules that may guide the scaling operations, further improving accuracy of scaling while improving the interface through which administrators interact with the system in easy natural language. Further, the generative AI model may predict (e.g., based on the behavior information or the matrix) future crawling operations based on detecting crawling operations and may pre-emptively allocate resources for the predicted operations to promote effective resource usage for the web crawling bots with reduced resource waste. Further, the subject matter described herein may improve resource allocation dynamically or in real-time, reducing both operational costs and performance issues. The subject matter described herein further provides options for administrators to configure conditions (e.g., such as scaling up the most-hit X URLs by a percentage if a specified quantity of bots are detected that is doing Y% utilization in last crawl with specific percentage of web content accessed), thus providing a more granular and efficient approach to resource scaling.

It should be appreciated by a person skilled in the art that one or more aspects of the disclosure may be implemented in a system 100 to additionally, or alternatively, solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

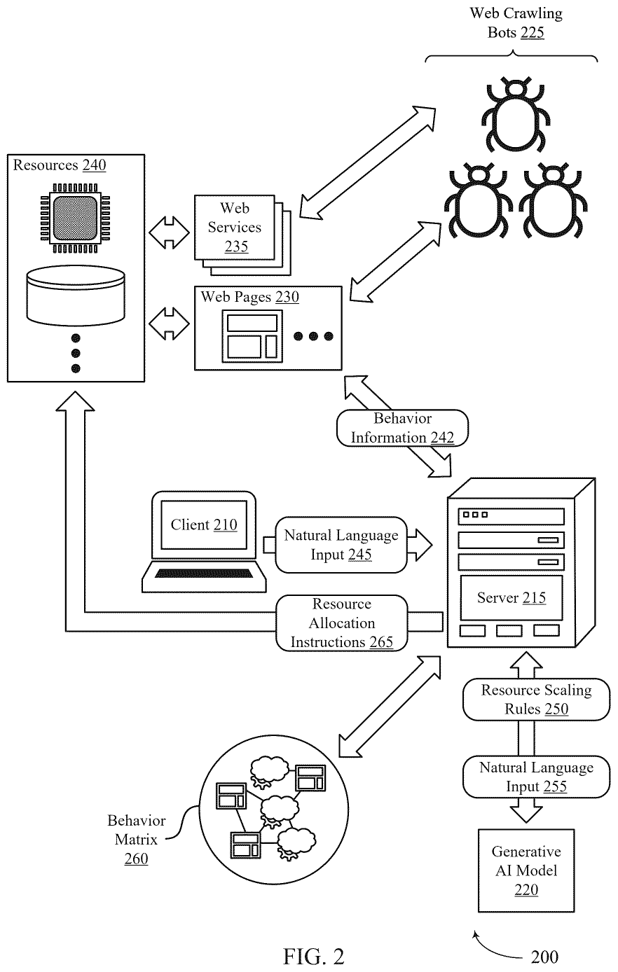

FIG. 2 shows an example of a resource allocation system 200 that supports dynamic resource scaling for web crawling in accordance with examples as disclosed herein. The processing system 200 may include a client 210, a server 215, and a generative AI model 220. The server 215 may represent a single server or processing entity, multiple servers or processing entities, a complete processing system, or any other entity capable of performing the operations described herein. The generative AI model 220 may be included as part of or otherwise associated with the server 215 or may operate independently of the server 215.

In some examples, the resource allocation system 200 may monitor the behavior of the web crawling bots 225 traversing a plurality of web pages 230, web services 235, URLs associated with the web pages 230, the web services 235, or both, one or more other elements, or any combination thereof, to generate behavior information 242 associated with the plurality of web crawling bots 225. The system may store the behavior information 242 in a behavior matrix 260. The behavior matrix 260 may include or describe some or all of the behavior information 242, including URL-to-URL transitions performed by the web crawling bots 225, information about what portions of the web services 235 or web pages 230 were rendered or otherwise activated or provided as a result of the web crawling operations of the web crawling bots 225, identifiers of the web crawling bots 225, or other information associated with the web crawling operations of the web crawling bots 225.

The resource allocation system 200 may receive the natural language input 245 that may include plain language configuration instructions that describe one or more rules for allocating the resources 240 associated with serving the plurality of web pages 230, the web services 235, or both. The resource allocation system 200 may process the natural language input 255 to determine, generate, formulate, or identify the resource scaling rules 250 that are expressed in, selected, or implied by the natural language input 255. The resource allocation system 200 may generate one or more resource allocation instructions 265 (e.g., based on the resource scaling rules 250, the behavior matrix 260, the behavior information 242, the natural language input 245, one or more administrator instructions or parameters, one or more actions performed by the web crawling bots 225, one or more other factors, operations, or information described herein, or any combination thereof) that may allocate the resources 240 for the web services 235, the web pages 230, one or more other web resources, or any combination thereof.

The resource allocation system 200 may detect the presence of a second web crawling bot 225 accessing one or more web pages 230, web services 235, or both. The system may allocate the processing resources 240 for the plurality of web pages 230, web services 235, or both, in accordance with the rules and based at least in part on detecting the presence of the second web crawling bot 225.

In some examples, the resource allocation system 200 may predict one or more actions that may be taken by the second web crawling bot 225 based on ongoing or “current” actions being performed by the web crawling bot 225, the behavior matrix 260, the behavior information 242, the natural language input 245, one or more administrator instructions or parameters, one or more actions performed by the web crawling bots 225, one or more other factors, operations, or information described herein, or any combination thereof. The resource allocation instructions 265 may be based at least in part on the one or more predicted actions.

The resource allocation system 200 may track the operations of web crawling bots across URLs served by the resource allocation system 200 or an associated resource allocation system 200 and may organize information gleaned from the tracking in a matrix of URL-to-URL transitions that may be analyzed by a generative AI model associated with the resource allocation system 200. An administrator may provide plain language input describing one or more rules for resource scaling and the plain language input may be interpreted by a generative AI model to generate or interpret the rules. The resource allocation system 200 may generate one or more resource allocation instructions to be provided to one or more elements of the resource allocation system 200 to implement the resource allocation. Further, the resource allocation system 200 may predict anticipate resource usage based on detected web crawling operations (e.g., ongoing crawling operations) and the behavior information and may further allocate pre-emptively allocate resources to accommodate future web crawling operations (e.g., associated with the ongoing crawling operations).

The resource allocation system 200 may offer improved resource utilization, including precision scaling in which the resource allocation system 200 uses real-time URL-to-URL transition data and AI-based predictions to determine which URLs will likely be accessed next, and in which direction or order in which contents of the URLs will be rendered or provided, promoting efficient allocation of resources. This reduces over-provisioning of resources while maintaining performance. The resource allocation system 200 may offer tailored scaling, in which different web crawler bots 225 (e.g., Googlebots or Bingbots) may follow unique paths through a website. This resource allocation system 200 tracks specific web crawler bots' 225 behavior, including its web service 235 access, web page 230 access, rendering associated with web service 235 access or web page 230 access. The resource allocation system 200 may tailor scaling recommendations based on the behavior of individual web crawler bots 225, further enhancing efficiency.

The resource allocation system 200 may offer improved cost efficiency. For example, by scaling up resources 240 for URLs that are highly likely to be accessed next, and scaling down the resources 240 for those that are less likely, the resource allocation system 200 helps reduce unnecessary server costs and energy consumption. Web hosting costs may be lowered as the resource allocation system 200 avoids blanket scaling strategies, which often result in resource wastage. Additionally, or alternatively, the resource allocation system 200 may offer intelligent cost management. Administrators may set easy and flexible custom conditions in natural language (e.g., in the natural language input 245), such as limiting resource 240 scaling to high-traffic URLs during peak crawler activity, thus improving performance without overspending on infrastructure.

The resource allocation system 200 may offer improved web application performance. For example, the resource allocation system 200 may offer real-time adaptation. The resource allocation system 200 may monitor and update URL resource considerations (e.g., continuously, periodically, randomly, in real-time, or following a schedule) ensuring that the web application can handle high traffic from web crawling bots 225 with reduced performance bottlenecks. In some examples, the resources 240 may be allocated dynamically, promoting seamless performance for web crawler bots 225 and human users alike. Additionally, or alternatively, the resource allocation system 200 may offer improved overload avoidance. By predicting which URLs will be accessed next, the resource allocation system 200 may proactively scale resources before traffic spikes occur, preventing delays or crashes caused by sudden, high loads.

The resource allocation system 200 may be more customizable and flexible. For example, the resource allocation system 200 may offer improved administrator control. Administrators may have full control over the scaling logic, with the ability to define rules in simple English in whatever condition they can think of, seamlessly. This gives flexibility to respond to different types of traffic patterns or business needs. Additionally, or alternatively, the resource allocation system 200 may offer adaptation to varying crawler behavior. Different web crawlers may have different behaviors. Some may access some URLs frequently, while others may skip them altogether. A resource allocation system 200 employing the subject matter described herein may adapt to each bot's behavior, leading to a more nuanced and efficient scaling strategy.

The resource allocation system 200 may offer improved predictive operations via generative AI. For example, the resource allocation system 200 may offer generative AI-powered predictions. By training the resource allocation system 200 on URL-to-URL access patterns, the AI model becomes increasingly accurate in predicting crawler behavior over time. This predictive intelligence helps web applications anticipate resource needs more effectively than traditional reactive scaling methods. Additionally, or alternatively, the resource allocation system 200 may offer improvements over time. The resource allocation system 200 continuously improves as more data is collected, making the scaling mechanism more accurate and responsive with each iteration.

The resource allocation system 200 may offer improved or enhanced control over web crawling bots. For example, the resource allocation system 200 may handle multiple bots simultaneously. In situations where multiple web crawlers are active on a site, the resource allocation system 200 may provide the ability to scale resources selectively based on activity of individual bots. This may reduce resource saturation and may promote improved handling of simultaneous crawler traffic. Additionally, or alternatively, the resource allocation system 200 may offer scaling under heavy crawler loads. The resource allocation system 200 may manage large-scale crawler activity by dynamically allocating resources to high-priority URLs while keeping low-priority URLs scaled down, ensuring the application remains responsive even under heavy bot traffic.

The resource allocation system 200 may be scalable for large or complex web applications. For example, the resource allocation system 200 may offer efficient matrix management. The resource allocation system 200's matrix-based approach enables it to handle even large web apps with thousands of URLs. By identifying high-probability access patterns and predicting subsequent URL visits, the resource allocation system 200 can manage complex URL networks efficiently. Additionally, or alternatively, the resource allocation system 200 may offer support for high-capacity resource allocation systems. As web applications grow and become more complex, the resource allocation system 200 scales the resources 240 accordingly, ensuring that resource scaling remains appropriate regardless of the size of the web pages 230, the web services 235, or both.

The resource allocation system 200 may offer reduced administrative overhead. For example, the resource allocation system 200 may offer automation of resource management. The resource allocation system 200 automates at least a portion of the resource management process, from monitoring URL access patterns to making intelligent scaling decisions, significantly reducing the manual intervention performed by resource allocation system 200 administrators. Additionally, or alternatively, the resource allocation system 200 may offer set and forget functionality. Once scaling conditions are configured by administrators (e.g., through the natural language input 245 from which the resource scaling rules 250 may be identified or generated), the resource allocation system 200 can autonomously manage scaling of the resources 240, freeing up teams to focus on other tasks.

The resource allocation system 200 may offer reduction or prevention of resource bottlenecks. For example, the resource allocation system 200 may offer proactive scaling. By predicting the next most probable URL web crawler bots 225 will visit, the resource allocation system 200 can proactively scale resources 240, reducing the likelihood of bottlenecks or delays in resource allocation (e.g., in associated with spikes in crawler traffic). Additionally, or alternatively, the resource allocation system 200 may reduce or avoid downtime. For example, the resource allocation system 200 may provide resourcing for URLs involved with web crawler indexing, reducing the risk of downtime or slow response times that could affect search engine optimization (SEO) performance.

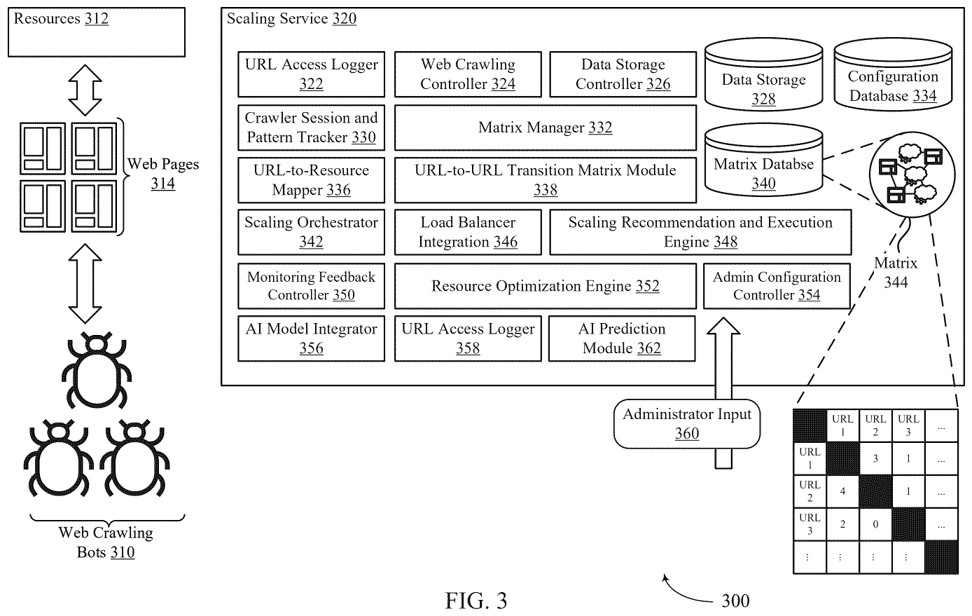

FIG. 3 shows an example of a resource allocation system 300 that supports dynamic resource scaling for web crawling in accordance with examples as disclosed herein. The resource allocation system 300 may allocate the resources 312 for the web pages 314 (or web applications or other web resources associated with the resource allocation system 300).

In some examples, the resource allocation system 300 may employ a scaling service 320, which may include a variety of elements, including a URL access logger 322, a web crawling controller 324, a data storage controller 326, data storage 328, a crawler session and pattern tracker 330, a matrix manager 332, a configuration database 334, a URL-to-resource mapper 336, a URL-to-URL transition matrix module 338, a matrix database 340, a scaling orchestrator 342, a load balancer integration 346, a scaling recommendation and execution engine 348, a monitoring feedback controller 350, a resource optimization engine 352, an admin configuration controller 354, an AI model integrator 356, a URL access logger 358, one or more other elements that carry out one or more operations described herein, or any combination thereof. Though some operations may be described as being performed by one or more elements, any of the elements described herein may perform any of the operations described herein.

A URL access logger 322 may be responsible for logging requests made to a URL or web page 314 by the web crawling bots 310. It may capture behavior information associated with the activity of the web crawling bots 310, such as the initial URL and any subsequent URLs visited by the crawler. In some examples, the URL access logger 322 may detect when a web crawler bot accesses a URL, identify the specific crawler bot to track patterns per bot type (e.g., Googlebot, Bingbot), record timestamps, user agents, web app content rendering, script execution, and other request details, (capture web requests made by crawler bots, store the accessed URL and the timestamp, perform one or more other operations, or any combination thereof. Any of the preceding information may be considered to be behavior information. In some examples, it the same bot accesses a subsequent URL within a session, the URL access logger 322 may mark or indicate such an operation as a transition.

For example, a web crawling controller 324 may detect traffic or operations of the web crawling bots 310 visiting the web pages 314. The web crawling controller 324 may analyze signatures to confirm the crawler and may record any behavior information associated with the operation of the web crawling bots 310.

The data storage controller 326 may aid in accessing, modifying, and managing the data storage 328. The data storage 328 may store any information described herein associated with the operation of the resource allocation system 300. For example, the data storage controller 326 may manage a database or data storage system (e.g., the data storage 328, the configuration database 334, the matrix database 340, one or more other storage entities, or any combination thereof) which may be used to persistently store the matrix 344, session information, access logs, or any other information described herein or associated with operations described herein. The data storage controller 326 may manage large-scale data, as the operations of the web crawling bots 310 may result in a large quantity of URLs and transitions that can accumulate over time. In addition, the data storage controller 326 may control or manage administrator configurations (e.g., in JavaScript Object Notation (JSON) format), which may be stored or managed with the configuration database 334 or other storage. For example, the data storage controller may store the matrix 344, keep logs of crawler sessions and URL or web page 314 access sequences, including bot usage patterns, archive historical data for performance, perform one or more other operations, or any combination thereof.

The crawler session and pattern tracker 330 may identify individual crawler sessions and may group URL requests made by a same bot (e.g., within a specific timeframe). It may be desirable to associate a sequence of URL or web page 314 accesses as a single “session” for a crawler. In addition, it checks the access pattern also. Such associations or patterns (or other information obtained or processed by the crawler session and pattern tracker 330) may be stored in the matrix 344 or in other storage. As mentioned earlier, it is not just the URLs that may be stored. Rather, the other information may be stored and analyzed, such as time spent to get rendered contents, what parts of web data were fetched by the web crawling bots 310, response operations performed by the web crawling bots 310 after fetching web content, levels or quantities of scripts executed in the content of the web pages 314, a level or quantity of nested drill downs, one or more other items of information, or any combination thereof. Such information may improve the analysis of URL transitions and other operations performed by the web crawling bots 310 and the use of the resources 312 to serve the web pages 314. Such a module may track when a web crawler session begins and ends, group all URLs accessed during a single session, feed this information into the URL-to-URL transition matrix 344, perform one or more other operations, or any combination thereof.

The matrix manager 332 may update the URL-to-URL transition matrix 344 in real-time, periodically, aperiodically, in response to a request, or in another manner. If a transition is detected (e.g., via the URL access logger 322 or the crawler session and pattern tracker 330), the matrix manager 332 may update one or more corresponding cells in the matrix 344. Each URL in the web pages 314 may be treated as a node in the matrix 344. When a web crawler accesses one URL and then proceeds to another, the system may record this transition in the matrix 344 (e.g., along with other information associated with the transition or other operations performed by the web crawling bots 310 as described herein). For example, the matrix 344 may record access probabilities for each URL pair (e.g., determined by a generative AI model or based on the operations of the web crawling bots 310), indicating how likely it is that one URL will be accessed after another. For example, such a likelihood be expressed as a value from 0 to 1, where 0 is a 0% likelihood and 1 is a 100% likelihood. Other scales may be used. URLs that are accessed more frequently by web crawlers may be assigned higher probabilities.

For example, the matrix manager 332 may receive input from the URL access logger 358, the crawler session and pattern tracker 330, or both. The matrix manager 332 may update the matrix 344 with new transitions or other behavior information or manage large matrices efficiently. In some examples, the matrix manager 332 may implement a sparse matrix approach for web apps with many URLs, perform one or more additional operations, or any combination thereof.

The configuration database 334 may store one or more configurations associated with operation of the resource allocation system 300. For example, one or more configurations defined by an administrator through natural language, one or more rules determined, generated, or selected based on analysis or interpretation of the natural language input (e.g., through the use of a generative AI model), or other configuration parameters, rules, or information may be stored therein. In some examples, the data storage controller 326 may manage the configuration database 334.

The URL-to-resource mapper 336 may map the resources 312 associated with a URL to return rendered web app contents when web crawling bots traffic coming to the web app for the URL.

The URL-to-URL transition matrix module 338 may construct and maintain the matrix 344 that tracks transitions between URLs. The rows and columns of the matrix 344 may represent individual URLs. Each cell of the matrix 344 may record the quantity of transitions from one URL (e.g., a current URL) to another (e.g., a next URL). Such an element or module may maintain a matrix M (e.g., the matrix 344) where M[i][j] represents the access and usage pattern of the bot transitioned from URL i to URL j, including how contents of URL i, URL j, or both, may be rendered. In some examples, the matrix 344 gets updated after a transition is detected. In some examples, the probabilities of transitions between URLs can be calculated from the matrix 344 for AI training.

The matrix database 340 may store the matrix 344 (or multiple matrices 344) that includes one or more indications of the behavior information. In some examples, the data storage controller 326 may manage the matrix database 340.

The scaling orchestrator 342 may serve as the central command hub within the Dynamic Scaling Engine. Additionally, or alternatively, the scaling orchestrator 342 may act as the unified point of coordination for some or all scaling activities, simplifying management and oversight. Its primary role is to manage and coordinate the scaling of web application URL related resources 312 based on real-time data and predictive insights derived from web crawler bot activities. By interpreting AI-generated recommendations and enforcing predefined scaling policies, the scaling orchestrator 342 may promote efficient and responsible allocation of the resources 312, aligning with the dynamic nature of the behavior of the web crawling bots 310.

In some examples, the load balancer integration 346 may balance loads for some or all operations described herein across various processing resources, storage resources, and other resources used for the operation of the resource allocation system 300.

The scaling recommendations and execution engine 348 may generate scaling recommendations based on the trained generative AI model and administrator-specified rules. These are then communicated to the hosting servers for the web pages 314, which adjust the resource allocation accordingly. This ensures that each URL receives the appropriate quantity of resources 312 based on current and predicted traffic patterns, reducing unnecessary resource usage while maintaining improved performance. In some examples, the generative AI model may be used to generate the instructions transmitted to the hosting servers for the web pages 314 (e.g., based on natural language input, one or more scaling rules, or other information as described herein).

The monitoring feedback controller 350 may receive performance and utilization data from the monitoring feedback controller 350 to assess the effectiveness of scaling actions done and make adjustments for running as well as future operations.

The resource optimization engine 352 may manage one or more resources of the resource allocation system 300. For example, the resource optimization engine 352 may determine an appropriate quantity of resources 312 that are to be used for serving a URL or providing a web service, such as the web pages 314 (e.g., in accordance with any of the techniques described herein) and may generate or provide one or more instructions for such resource allocation operations.

The admin configuration controller 354 may allow administrators to set scaling rules in the system based on this data in simple plain language format, such as in the administrator input 360. For example, such a plain language input (e.g., the administrator input 360) may be expressed as the following: “If URL X is accessed by a web crawler with all its scripts executed and content rendered in Y time, automatically scale up resources 312 for the next two most probable URLs which consumed 80% resources in the last bot crawl.” Another example of such input (e.g., the administrator input 360) may be: “Scale up resources for the X most frequently hit URLs by Y% when Y quantity of bots are detected to render Z quantity of URLs for 100% web app content.” Such scaling conditions may allow for a flexible response to the web crawling bot 310 traffic without requiring constant manual intervention. Such natural language input provides users with ease and high flexibility to configure a wide range of condition that are highly customizable to a particular use case or computational setup.

The AI model integrator 356 may receive or extract data from the matrix 344 and feed it into a generative AI system or generative AI model, which may be trained to predict the most probable next URL accesses based on historical patterns. Any 3rd generative AI solution can be used. Over time, the model may improve its ability to forecast web crawler behavior, providing increasingly accurate scaling recommendations.

The URL access logger 358 may log URL access activity (or other web crawling activity) of the web crawling bots 310 that may be collected and stored in the matrix 344 and analyze by a generative AI model or other processing in accordance with the techniques described herein.

In some examples, the scaling orchestrator 342 or one or more other elements of the resource allocation system 300 may interface directly with the AI prediction module 362, which may process the matrix 344 to forecast future URL access patterns. The AI prediction module 362 may receive detailed scaling recommendations, such as which URLs may benefit from additional resources 312 and by what percentage. In some examples, before executing any scaling action, the scaling orchestrator 342 may determine whether the recommended changes comply with one or more scaling policies or constraints (e.g., maximum resource limits, budget restrictions, or other policies or restraints, such as organizational or departmental restraints). In some examples, the scaling orchestrator 342 may identify and resolve potential conflicts between multiple scaling instructions, prioritizing actions based on urgency, importance, or predefined hierarchies or rules (e.g., the rules extracted, generated or selected based on the plain language input from administrators, such as the administrator input 360). In some examples, the scaling orchestrator may ensure that resource scaling maintains balanced load distribution across servers or containers, preventing hotspots and bottlenecks.

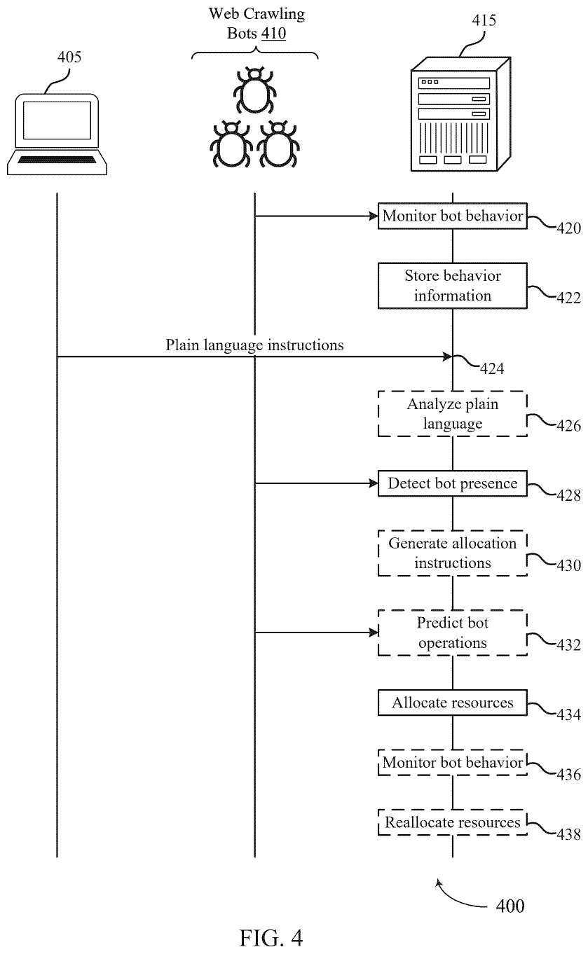

FIG. 4 shows an example of a process flow 400 that supports dynamic resource scaling for web crawling in accordance with examples as disclosed herein.

The process flow 400 may implement various aspects of the present disclosure described herein. The elements described in the process flow 400 (e.g., server 415, client 405, and web crawling bots 410) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the server 415 may monitor behavior of a plurality of first web crawling bots 410 traversing a plurality of web pages to generate behavior information associated with the plurality of first web crawling bots 410.

At 422, the server 415 may store at least a portion of the behavior information in a behavior matrix. In some examples, the behavior information may include URL transition information that describes URL-to-URL transitions performed by the plurality of first web crawling bots 410 across the plurality of web pages, one or more indications of content rendered in response to the traversal of the plurality of first web crawling bots 410 across the plurality of web pages, rendering time information, web data fetching information, web crawling bot requests, web crawling bot responses, script execution information, nested operation information, one or more identifiers associated with the plurality of first web crawling bots 410, a quantity of the plurality of first web crawling bots 410, or any combination thereof.

At 424, the server 415 may receive (e.g., from the client 405) plain language configuration instructions that describe one or more rules for allocating processing resources associated with serving the plurality of web pages.

At 426, the server 415 may analyze, with a generative AI model, the plain language configuration instructions to generate the one or more rules.

At 428, the server 415 may detect a presence of a second web crawling bot accessing one or more first web pages of the plurality of web pages.

At 430, the server 415 may generate one or more allocation instructions for the processing resources based on a generative AI model analysis of the behavior information, the one or more rules, or any combination thereof and allocating the processing resources is based on the one or more allocation instructions.

At 432, the server 415 may predict, with a generative AI model, that the second web crawling bot will access one or more second web pages of the plurality of web pages based on the behavior information and detecting the presence of the second web crawling bot accessing the one or more first web pages.

At 434, the server 415 may allocate the processing resources for the plurality of web pages in accordance with the one or more rules and based on detecting the presence of the second web crawling bot. In some examples, the server 415 may allocate at least a portion of the processing resources for the one or more second web pages based on the predicting. In some examples, the server 415 may allocate the processing resources for individual web pages of the plurality of web pages based on the behavior information.

At 436, the server 415 may monitor behavior of the second web crawling bot and allocation of the processing resources for the plurality of web pages.

At 438, the server 415 may reallocate the processing resources for the plurality of web pages based on the monitoring and one or more allocation metrics.

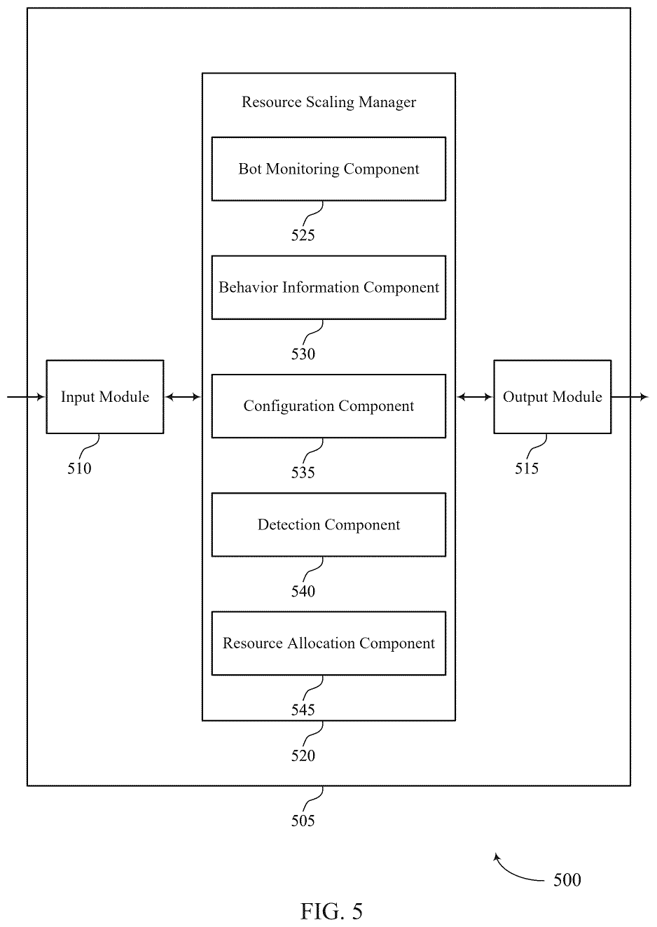

FIG. 5 shows a block diagram 500 of a device 505 that supports dynamic resource scaling for web crawling in accordance with examples as disclosed herein. The device 505 may include an input module 510, an output module 515, and a resource scaling manager 520. The device 505, or one or more components of the device 505 (e.g., the input module 510, the output module 515, the resource scaling manager 520), may include at least one processor, which may be coupled with at least one memory, to support the described techniques. Each of these components may be in communication with one another (e.g., via one or more buses).

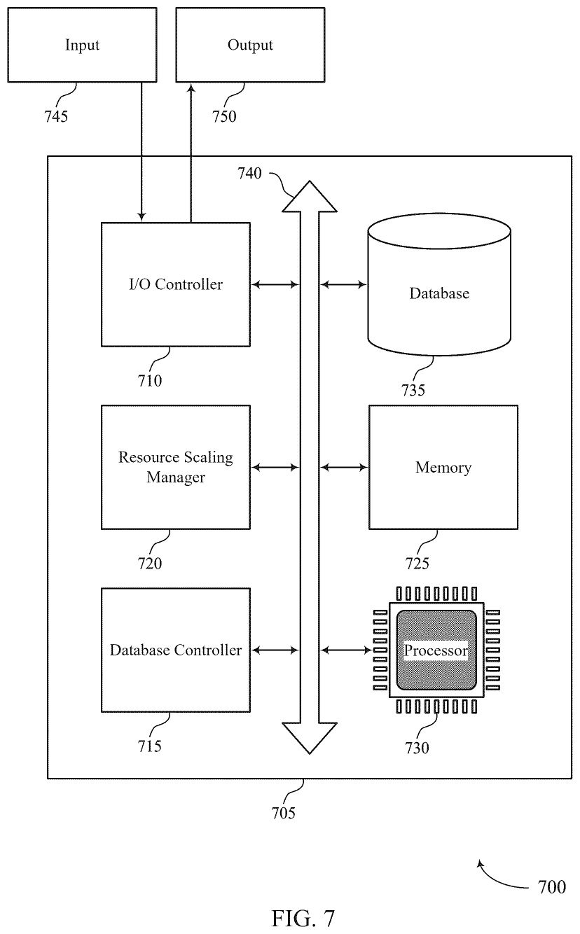

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the resource scaling manager 520 to support dynamic resource scaling for web crawling. In some cases, the input module 510 may be a component of an input/output (I/O) controller 710 as described with reference to FIG. 7.

The output module 515 may manage output signals for the device 505. For example, the output module 515 may receive signals from other components of the device 505, such as the resource scaling manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the resource scaling manager 520 may include a bot monitoring component 525, a behavior information component 530, a configuration component 535, a detection component 540, a resource allocation component 545, or any combination thereof. In some examples, the resource scaling manager 520, or various components thereof, may be configured to perform various operations (e.g., receiving, monitoring, transmitting) using or otherwise in cooperation with the input module 510, the output module 515, or both. For example, the resource scaling manager 520 may receive information from the input module 510, send information to the output module 515, or be integrated in combination with the input module 510, the output module 515, or both to receive information, transmit information, or perform various other operations as described herein.

The resource scaling manager 520 may support data processing in accordance with examples as disclosed herein. The bot monitoring component 525 may be configured to support monitoring behavior of a set of multiple first web crawling bots traversing a set of multiple web pages to generate behavior information associated with the set of multiple first web crawling bots. The behavior information component 530 may be configured to support storing at least a portion of the behavior information in a behavior matrix. The configuration component 535 may be configured to support receiving plain language configuration instructions that describe one or more rules for allocating processing resources associated with serving the set of multiple web pages. The detection component 540 may be configured to support detecting a presence of a second web crawling bot accessing one or more first web pages of the set of multiple web pages. The resource allocation component 545 may be configured to support allocating the processing resources for the set of multiple web pages in accordance with the one or more rules and based on detecting the presence of the second web crawling bot.

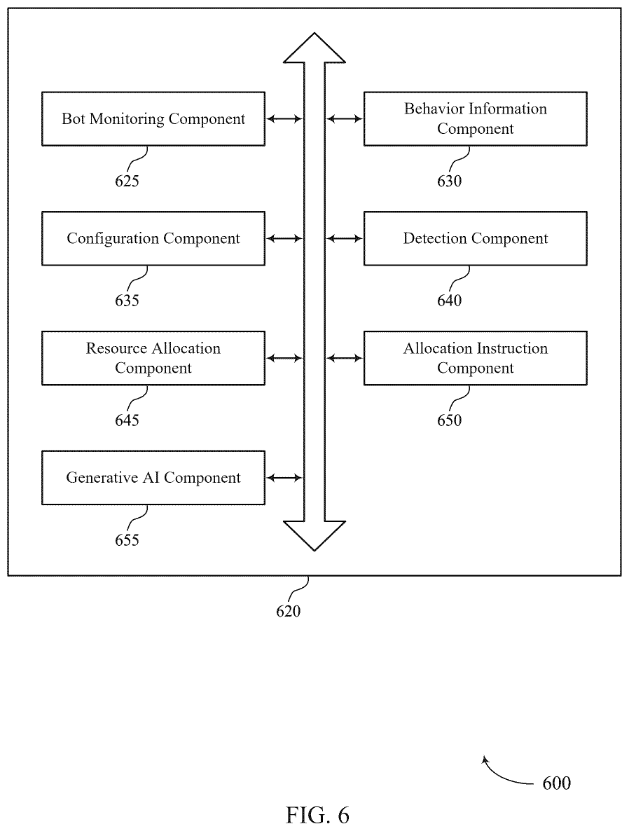

FIG. 6 shows a block diagram 600 of a resource scaling manager 620 that supports dynamic resource scaling for web crawling in accordance with examples as disclosed herein. The resource scaling manager 620 may be an example of aspects of a resource scaling manager or a resource scaling manager 520, or both, as described herein. The resource scaling manager 620, or various components thereof, may be an example of means for performing various aspects of dynamic resource scaling for web crawling as described herein. For example, the resource scaling manager 620 may include a bot monitoring component 625, a behavior information component 630, a configuration component 635, a detection component 640, a resource allocation component 645, an allocation instruction component 650, a generative AI component 655, or any combination thereof. Each of these components, or components of subcomponents thereof (e.g., one or more processors, one or more memories), may communicate, directly or indirectly, with one another (e.g., via one or more buses).

The resource scaling manager 620 may support data processing in accordance with examples as disclosed herein. The bot monitoring component 625 may be configured to support monitoring behavior of a set of multiple first web crawling bots traversing a set of multiple web pages to generate behavior information associated with the set of multiple first web crawling bots. The behavior information component 630 may be configured to support storing at least a portion of the behavior information in a behavior matrix. The configuration component 635 may be configured to support receiving plain language configuration instructions that describe one or more rules for allocating processing resources associated with serving the set of multiple web pages. The detection component 640 may be configured to support detecting a presence of a second web crawling bot accessing one or more first web pages of the set of multiple web pages. The resource allocation component 645 may be configured to support allocating the processing resources for the set of multiple web pages in accordance with the one or more rules and based on detecting the presence of the second web crawling bot.

In some examples, the allocation instruction component 650 may be configured to support generating one or more allocation instructions for the processing resources based on a generative artificial intelligence (AI) model analysis of the behavior information, the one or more rules, or any combination thereof, where allocating the processing resources is based on the one or more allocation instructions.

In some examples, the generative AI component 655 may be configured to support predicting, with a generative artificial intelligence (AI) model, that the second web crawling bot will access one or more second web pages of the set of multiple web pages based on the behavior information and detecting the presence of the second web crawling bot accessing the one or more first web pages. In some examples, the resource allocation component 645 may be configured to support allocating at least a portion of the processing resources for the one or more second web pages based on the predicting.

In some examples, the behavior information includes URL transition information that describes URL-to-URL transitions performed by the set of multiple first web crawling bots across the set of multiple web pages, one or more indications of content rendered in response to the traversal of the set of multiple first web crawling bots across the set of multiple web pages, rendering time information, web data fetching information, web crawling bot requests, web crawling bot responses, script execution information, nested operation information, one or more identifiers associated with the set of multiple first web crawling bots, a quantity of the set of multiple first web crawling bots, or any combination thereof.

In some examples, to support allocating the processing resources, the resource allocation component 645 may be configured to support allocating the processing resources for individual web pages of the set of multiple web pages based on the behavior information.

In some examples, the generative AI component 655 may be configured to support analyzing, with a generative artificial intelligence (AI) model, the plain language configuration instructions to generate the one or more rules.

In some examples, the bot monitoring component 625 may be configured to support monitoring behavior of the second web crawling bot and allocation of the processing resources for the set of multiple web pages. In some examples, the resource allocation component 645 may be configured to support reallocating the processing resources for the set of multiple web pages based on the monitoring and one or more allocation metrics.

FIG. 7 shows a diagram of a system 700 including a device 705 that supports dynamic resource scaling for web crawling in accordance with examples as disclosed herein. The device 705 may be an example of or include components of a device 505 as described herein. The device 705 may include components for bi-directional data communications including components for transmitting and receiving communications, such as a resource scaling manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting dynamic resource scaling for web crawling). The processor 730 may be an example of a single processor or multiple processors. For example, the device 705 may include one or more processors 730.

The resource scaling manager 720 may support data processing in accordance with examples as disclosed herein. For example, the resource scaling manager 720 may be configured to support monitoring behavior of a set of multiple first web crawling bots traversing a set of multiple web pages to generate behavior information associated with the set of multiple first web crawling bots. The resource scaling manager 720 may be configured to support storing at least a portion of the behavior information in a behavior matrix. The resource scaling manager 720 may be configured to support receiving plain language configuration instructions that describe one or more rules for allocating processing resources associated with serving the set of multiple web pages. The resource scaling manager 720 may be configured to support detecting a presence of a second web crawling bot accessing one or more first web pages of the set of multiple web pages. The resource scaling manager 720 may be configured to support allocating the processing resources for the set of multiple web pages in accordance with the one or more rules and based on detecting the presence of the second web crawling bot.

By including or configuring the resource scaling manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

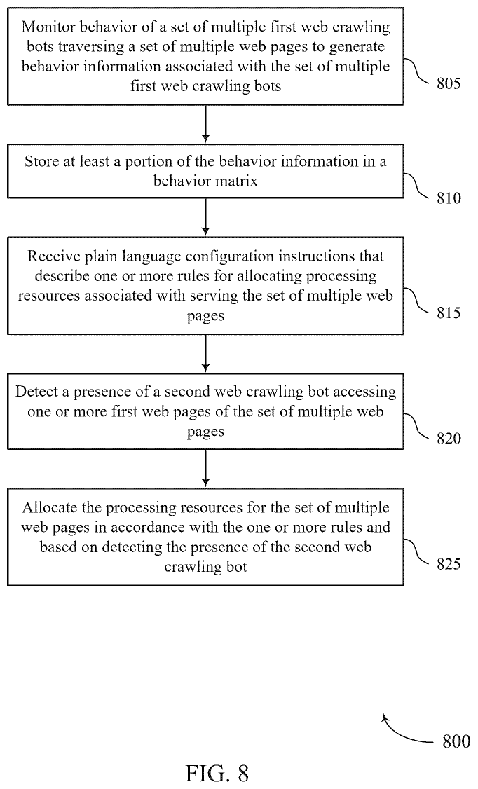

FIG. 8 shows a flowchart illustrating a method 800 that supports dynamic resource scaling for web crawling in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include monitoring behavior of a set of multiple first web crawling bots traversing a set of multiple web pages to generate behavior information associated with the set of multiple first web crawling bots. The operations of 805 may be performed in accordance with examples as disclosed herein. In some examples, aspects of the operations of 805 may be performed by a bot monitoring component 625 as described with reference to FIG. 6.

At 810, the method may include storing at least a portion of the behavior information in a behavior matrix. The operations of 810 may be performed in accordance with examples as disclosed herein. In some examples, aspects of the operations of 810 may be performed by a behavior information component 630 as described with reference to FIG. 6.

At 815, the method may include receiving plain language configuration instructions that describe one or more rules for allocating processing resources associated with serving the set of multiple web pages. The operations of 815 may be performed in accordance with examples as disclosed herein. In some examples, aspects of the operations of 815 may be performed by a configuration component 635 as described with reference to FIG. 6.

At 820, the method may include detecting a presence of a second web crawling bot accessing one or more first web pages of the set of multiple web pages. The operations of 820 may be performed in accordance with examples as disclosed herein. In some examples, aspects of the operations of 820 may be performed by a detection component 640 as described with reference to FIG. 6.

At 825, the method may include allocating the processing resources for the set of multiple web pages in accordance with the one or more rules and based on detecting the presence of the second web crawling bot. The operations of 825 may be performed in accordance with examples as disclosed herein. In some examples, aspects of the operations of 825 may be performed by a resource allocation component 645 as described with reference to FIG. 6.

A method for data processing by an application server is described. The method may include monitoring behavior of a set of multiple first web crawling bots traversing a set of multiple web pages to generate behavior information associated with the set of multiple first web crawling bots, storing at least a portion of the behavior information in a behavior matrix, receiving plain language configuration instructions that describe one or more rules for allocating processing resources associated with serving the set of multiple web pages, detecting a presence of a second web crawling bot accessing one or more first web pages of the set of multiple web pages, and allocating the processing resources for the set of multiple web pages in accordance with the one or more rules and based on detecting the presence of the second web crawling bot.

An application server for data processing is described. The application server may include one or more memories storing processor executable code, and one or more processors coupled with the one or more memories. The one or more processors may individually or collectively be operable to execute the code to cause the application server to monitor behavior of a set of multiple first web crawling bots traversing a set of multiple web pages to generate behavior information associated with the set of multiple first web crawling bots, store at least a portion of the behavior information in a behavior matrix, receive plain language configuration instructions that describe one or more rules for allocating processing resources associated with serving the set of multiple web pages, detect a presence of a second web crawling bot accessing one or more first web pages of the set of multiple web pages, and allocate the processing resources for the set of multiple web pages in accordance with the one or more rules and based on detecting the presence of the second web crawling bot.

Another application server for data processing is described. The application server may include means for monitoring behavior of a set of multiple first web crawling bots traversing a set of multiple web pages to generate behavior information associated with the set of multiple first web crawling bots, means for storing at least a portion of the behavior information in a behavior matrix, means for receiving plain language configuration instructions that describe one or more rules for allocating processing resources associated with serving the set of multiple web pages, means for detecting a presence of a second web crawling bot accessing one or more first web pages of the set of multiple web pages, and means for allocating the processing resources for the set of multiple web pages in accordance with the one or more rules and based on detecting the presence of the second web crawling bot.

A non-transitory computer-readable medium storing code for data processing is described. The code may include instructions executable by one or more processors to monitor behavior of a set of multiple first web crawling bots traversing a set of multiple web pages to generate behavior information associated with the set of multiple first web crawling bots, store at least a portion of the behavior information in a behavior matrix, receive plain language configuration instructions that describe one or more rules for allocating processing resources associated with serving the set of multiple web pages, detect a presence of a second web crawling bot accessing one or more first web pages of the set of multiple web pages, and allocate the processing resources for the set of multiple web pages in accordance with the one or more rules and based on detecting the presence of the second web crawling bot.

Some examples of the method, application servers, and non-transitory computer-readable medium described herein may further include operations, features, means, or instructions for generating one or more allocation instructions for the processing resources based on a generative artificial intelligence (AI) model analysis of the behavior information, the one or more rules, or any combination thereof, where allocating the processing resources may be based on the one or more allocation instructions.

Some examples of the method, application servers, and non-transitory computer-readable medium described herein may further include operations, features, means, or instructions for predicting, with a generative artificial intelligence (AI) model, that the second web crawling bot will access one or more second web pages of the set of multiple web pages based on the behavior information and detecting the presence of the second web crawling bot accessing the one or more first web pages and allocating at least a portion of the processing resources for the one or more second web pages based on the predicting.

In some examples of the method, application servers, and non-transitory computer-readable medium described herein, the behavior information includes URL transition information that describes URL-to-URL transitions performed by the set of multiple first web crawling bots across the set of multiple web pages, one or more indications of content rendered in response to the traversal of the set of multiple first web crawling bots across the set of multiple web pages, rendering time information, web data fetching information, web crawling bot requests, web crawling bot responses, script execution information, nested operation information, one or more identifiers associated with the set of multiple first web crawling bots, a quantity of the set of multiple first web crawling bots, or any combination thereof.

In some examples of the method, application servers, and non-transitory computer-readable medium described herein, allocating the processing resources may include operations, features, means, or instructions for allocating the processing resources for individual web pages of the set of multiple web pages based on the behavior information.

Some examples of the method, application servers, and non-transitory computer-readable medium described herein may further include operations, features, means, or instructions for analyzing, with a generative artificial intelligence (AI) model, the plain language configuration instructions to generate the one or more rules.

Some examples of the method, application servers, and non-transitory computer-readable medium described herein may further include operations, features, means, or instructions for monitoring behavior of the second web crawling bot and allocation of the processing resources for the set of multiple web pages and reallocating the processing resources for the set of multiple web pages based on the monitoring and one or more allocation metrics.

The following provides an overview of aspects of the present disclosure:

Aspect 1: A method for data processing at an application server, comprising: monitoring behavior of a plurality of first web crawling bots traversing a plurality of web pages to generate behavior information associated with the plurality of first web crawling bots; storing at least a portion of the behavior information in a behavior matrix; receiving plain language configuration instructions that describe one or more rules for allocating processing resources associated with serving the plurality of web pages; detecting a presence of a second web crawling bot accessing one or more first web pages of the plurality of web pages; and allocating the processing resources for the plurality of web pages in accordance with the one or more rules and based at least in part on detecting the presence of the second web crawling bot.

Aspect 2: The method of aspect 1, further comprising: generating one or more allocation instructions for the processing resources based at least in part on a generative artificial intelligence (AI) model analysis of the behavior information, the one or more rules, or any combination thereof, wherein allocating the processing resources is based at least in part on the one or more allocation instructions.

Aspect 3: The method of any of aspects 1 through 2, further comprising: predicting, with a generative artificial intelligence (AI) model, that the second web crawling bot will access one or more second web pages of the plurality of web pages based at least in part on the behavior information and detecting the presence of the second web crawling bot accessing the one or more first web pages; and allocating at least a portion of the processing resources for the one or more second web pages based at least in part on the predicting.

Aspect 4: The method of any of aspects 1 through 3, wherein the behavior information comprises URL transition information that describes URL-to-URL transitions performed by the plurality of first web crawling bots across the plurality of web pages, one or more indications of content rendered in response to the traversal of the plurality of first web crawling bots across the plurality of web pages, rendering time information, web data fetching information, web crawling bot requests, web crawling bot responses, script execution information, nested operation information, one or more identifiers associated with the plurality of first web crawling bots, a quantity of the plurality of first web crawling bots, or any combination thereof.

Aspect 5: The method of any of aspects 1 through 4, wherein allocating the processing resources comprises: allocating the processing resources for individual web pages of the plurality of web pages based at least in part on the behavior information.

Aspect 6: The method of any of aspects 1 through 5, further comprising: analyzing, with a generative artificial intelligence (AI) model, the plain language configuration instructions to generate the one or more rules.

Aspect 7: The method of any of aspects 1 through 6, further comprising: monitoring behavior of the second web crawling bot and allocation of the processing resources for the plurality of web pages; and reallocating the processing resources for the plurality of web pages based at least in part on the monitoring and one or more allocation metrics.

Aspect 8: An application server for data processing, comprising one or more memories storing processor-executable code, and one or more processors coupled with the one or more memories and individually or collectively operable to execute the code to cause the application server to perform a method of any of aspects 1 through 7.

Aspect 9: An application server for data processing, comprising at least one means for performing a method of any of aspects 1 through 7.

Aspect 10: A non-transitory computer-readable medium storing code for data processing, the code comprising instructions executable by one or more processors to perform a method of any of aspects 1 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
monitoring behavior of a plurality of first web crawling bots traversing a plurality of web pages to generate behavior information associated with the plurality of first web crawling bots;
storing at least a portion of the behavior information in a behavior matrix;
receiving plain language configuration instructions that describe one or more rules for allocating processing resources associated with serving the plurality of web pages;
detecting a presence of a second web crawling bot accessing one or more first web pages of the plurality of web pages; and
allocating the processing resources for the plurality of web pages in accordance with the one or more rules and based at least in part on detecting the presence of the second web crawling bot.

2. The method of claim 1, further comprising:
generating one or more allocation instructions for the processing resources based at least in part on a generative artificial intelligence (AI) model analysis of the behavior information, the one or more rules, or any combination thereof, wherein allocating the processing resources is based at least in part on the one or more allocation instructions.

3. The method of claim 1, further comprising:
predicting, with a generative artificial intelligence (AI) model, that the second web crawling bot will access one or more second web pages of the plurality of web pages based at least in part on the behavior information and detecting the presence of the second web crawling bot accessing the one or more first web pages; and
allocating at least a portion of the processing resources for the one or more second web pages based at least in part on the predicting.

4. The method of claim 1, wherein the behavior information comprises URL transition information that describes URL-to-URL transitions performed by the plurality of first web crawling bots across the plurality of web pages, one or more indications of content rendered in response to the traversal of the plurality of first web crawling bots across the plurality of web pages, rendering time information, web data fetching information, web crawling bot requests, web crawling bot responses, script execution information, nested operation information, one or more identifiers associated with the plurality of first web crawling bots, a quantity of the plurality of first web crawling bots, or any combination thereof.

5. The method of claim 1, wherein allocating the processing resources comprises:
allocating the processing resources for individual web pages of the plurality of web pages based at least in part on the behavior information.

6. The method of claim 1, further comprising:
analyzing, with a generative artificial intelligence (AI) model, the plain language configuration instructions to generate the one or more rules.

7. The method of claim 1, further comprising:
monitoring behavior of the second web crawling bot and allocation of the processing resources for the plurality of web pages; and
reallocating the processing resources for the plurality of web pages based at least in part on the monitoring and one or more allocation metrics.

8. An application server for data processing, comprising:
one or more memories storing processor-executable code; and
one or more processors coupled with the one or more memories and individually or collectively operable to execute the code to cause the application server to:
monitor behavior of a plurality of first web crawling bots traversing a plurality of web pages to generate behavior information associated with the plurality of first web crawling bots;
store at least a portion of the behavior information in a behavior matrix;
receive plain language configuration instructions that describe one or more rules for allocating processing resources associated with serving the plurality of web pages;
detect a presence of a second web crawling bot accessing one or more first web pages of the plurality of web pages; and
allocate the processing resources for the plurality of web pages in accordance with the one or more rules and based at least in part on detecting the presence of the second web crawling bot.

9. The application server of claim 8, wherein the one or more processors are individually or collectively further operable to execute the code to cause the application server to:
generate one or more allocation instructions for the processing resources based at least in part on a generative artificial intelligence (AI) model analysis of the behavior information, the one or more rules, or any combination thereof, wherein allocating the processing resources is based at least in part on the one or more allocation instructions.

10. The application server of claim 8, wherein the one or more processors are individually or collectively further operable to execute the code to cause the application server to:
predict, with a generative artificial intelligence (AI) model, that the second web crawling bot will access one or more second web pages of the plurality of web pages based at least in part on the behavior information and detecting the presence of the second web crawling bot accessing the one or more first web pages; and
allocate at least a portion of the processing resources for the one or more second web pages based at least in part on the predicting.

11. The application server of claim 8, wherein the behavior information comprises URL transition information that describes URL-to-URL transitions performed by the plurality of first web crawling bots across the plurality of web pages, one or more indications of content rendered in response to the traversal of the plurality of first web crawling bots across the plurality of web pages, rendering time information, web data fetching information, web crawling bot requests, web crawling bot responses, script execution information, nested operation information, one or more identifiers associated with the plurality of first web crawling bots, a quantity of the plurality of first web crawling bots, or any combination thereof.

12. The application server of claim 8, wherein, to allocate the processing resources, the one or more processors are individually or collectively operable to execute the code to cause the application server to:
allocate the processing resources for individual web pages of the plurality of web pages based at least in part on the behavior information.

13. The application server of claim 8, wherein the one or more processors are individually or collectively further operable to execute the code to cause the application server to:
analyze, with a generative artificial intelligence (AI) model, the plain language configuration instructions to generate the one or more rules.

14. The application server of claim 8, wherein the one or more processors are individually or collectively further operable to execute the code to cause the application server to:
monitor behavior of the second web crawling bot and allocation of the processing resources for the plurality of web pages; and
reallocate the processing resources for the plurality of web pages based at least in part on the monitoring and one or more allocation metrics.

15. A non-transitory computer-readable medium storing code for data processing, the code comprising instructions executable by one or more processors to:
monitor behavior of a plurality of first web crawling bots traversing a plurality of web pages to generate behavior information associated with the plurality of first web crawling bots;
store at least a portion of the behavior information in a behavior matrix;
receive plain language configuration instructions that describe one or more rules for allocating processing resources associated with serving the plurality of web pages;
detect a presence of a second web crawling bot accessing one or more first web pages of the plurality of web pages; and
allocate the processing resources for the plurality of web pages in accordance with the one or more rules and based at least in part on detecting the presence of the second web crawling bot.

16. The non-transitory computer-readable medium of claim 15, wherein the instructions are further executable by the one or more processors to:
generate one or more allocation instructions for the processing resources based at least in part on a generative artificial intelligence (AI) model analysis of the behavior information, the one or more rules, or any combination thereof, wherein allocating the processing resources is based at least in part on the one or more allocation instructions.

17. The non-transitory computer-readable medium of claim 15, wherein the instructions are further executable by the one or more processors to:
predict, with a generative artificial intelligence (AI) model, that the second web crawling bot will access one or more second web pages of the plurality of web pages based at least in part on the behavior information and detecting the presence of the second web crawling bot accessing the one or more first web pages; and
allocate at least a portion of the processing resources for the one or more second web pages based at least in part on the predicting.

18. The non-transitory computer-readable medium of claim 15, wherein the behavior information comprises URL transition information that describes URL-to-URL transitions performed by the plurality of first web crawling bots across the plurality of web pages, one or more indications of content rendered in response to the traversal of the plurality of first web crawling bots across the plurality of web pages, rendering time information, web data fetching information, web crawling bot requests, web crawling bot responses, script execution information, nested operation information, one or more identifiers associated with the plurality of first web crawling bots, a quantity of the plurality of first web crawling bots, or any combination thereof.

19. The non-transitory computer-readable medium of claim 15, wherein the instructions to allocate the processing resources are executable by the one or more processors to:
allocate the processing resources for individual web pages of the plurality of web pages based at least in part on the behavior information.

20. The non-transitory computer-readable medium of claim 15, wherein the instructions are further executable by the one or more processors to:
analyze, with a generative artificial intelligence (AI) model, the plain language configuration instructions to generate the one or more rules.
